(19) United States
(12) Patent Application Publication
(10) Pub. No.: US 2007/0076423 A1
(43) Pub. Date: Apr. 5, 2007

(54) LIQUID-EJECTING DEVICE AND RECORDING APPARATUS

(75) Inventor: Yoshitaka Shimada, Suwa-shi, Nagano-ken (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/536,529

(22) Filed: Sep. 28, 2006

(30) Foreign Application Priority Data
Sep. 30, 2005 (JP) 2005-287771

(51) Int. Cl. F21S 8/10

(52) U.S. Cl. 362/549

(57) ABSTRACT

A liquid-ejecting device includes a feed roller that conveys a medium, an ejection head that ejects a liquid while reciprocating along the medium, a rotational position detector including a rotational position detection scale to detect a rotational position of the feed roller, and a movement position detector including a movement position detection scale to detect a movement position of the ejection head. The rotational position detection scale and/or the movement position detection scale is subjected to a surface treatment that adapts at least one surface thereof to the liquid.

### BACKGROUND

1. Technical Field

The present invention relates to a liquid-ejecting device including a feed roller that conveys a medium, a rotational position detector that detects the rotational position of the feed roller, an ejection head that ejects a liquid while reciprocating along the medium, and a movement position detector that detects the movement position of the ejection head, and also relates to a recording apparatus including the liquid-ejecting device.

2. Related Art

A serial-head inkjet printer, one type of recording apparatus, has a transporting section including a feed roller that conveys a sheet of paper in a sub-scanning direction and a recording section including a carriage that ejects an ink from a recording head mounted thereon to perform recording while reciprocating in a main scanning direction. This type of inkjet printer includes a rotary encoder that detects the rotational position of the feed roller to control the transportation of the sheet of paper, and also includes a linear encoder that detects the movement position of the carriage to control the ejection of the ink from the recording head.

Transmission encoders are generally used as the rotary encoder and the linear encoder for their advantages including high definition, a relatively large scale-sensor gap, and easy assembly. However, foreign matter such as paper dust and ink mist tends to be suspended during the transportation and recording of a sheet of paper, and can adhere to scales and decrease the transportation accuracy and recording accuracy of the encoders. To avoid the problem, for example, JP-A-2000-141802 proposes an inkjet printer having a mechanism for removing and cleaning foreign matter with a blade, and JP-A-2001-191604 and JP-A-2004-188701 propose inkjet printers having a mechanism for preventing adhesion of foreign matter with air.

Any of the proposed mechanisms, however, requires an additional mechanical component. The use of the additional component increases component cost and requires the space for installation thereof. In addition, these mechanisms can only be applied to linear encoders. On the other hand, JP-A-2004-209846 proposes water-repellent treatment of scale surfaces, such as fluoropolymer coating, although this method is designed for magnetic encoders. Application of this method to transmission encoders may be expected to solve the above problem.

A scale surface subjected to a water-repellent treatment, however, repels ink adhering thereto and forms it into droplets. The surfaces of the droplets scatter (diffuse) most of light from a light-emitting device. Hence, an extreme decrease in detection accuracy is inevitable with the ink adhering to the scale surface.

### SUMMARY

An advantage of the invention is that it provides a liquid-ejecting device capable of preventing an extreme decrease in the detection accuracy of a rotational position detector and a movement position detector due to contamination thereof and also provides a recording apparatus including the liquid-ejecting device.

A liquid-ejecting device according to an aspect of the invention includes a feed roller that conveys a medium, an ejection head that ejects a liquid while reciprocating along the medium, a rotational position detector including a rotational position detection scale to detect a rotational position of the feed roller, and a movement position detector including a movement position detection scale to detect a movement position of the ejection head. The rotational position detection scale and/or the movement position detection scale is subjected to a surface treatment that adapts at least one surface thereof to the liquid.

This surface treatment can prevent an extreme decrease in detection accuracy because the liquid is not repelled or formed into droplets on the surface of the rotational position detection scale and/or the movement position detection scale when the liquid adheres thereto.

The surface treatment can impart an affinity for the liquid to the surface of the rotational position detection scale and/or the movement position detection scale to enhance wettability between the surface and the liquid. The liquid is therefore not repelled or formed into droplets on the surface of the rotational position detection scale and/or the movement position detection scale when the liquid adheres thereto. The surface treatment may be coating with a surfactant or a hydrophilic photocatalyst. Such a treatment can lower the surface tension of the liquid on the surface of the rotational position detection scale and/or the movement position detection scale to decrease the contact angle between the surface and the liquid. The liquid therefore becomes flat on the surface.

The rotational position detection scale and the movement position detection scale may be formed of polyethylene terephthalate to reduce component cost. In addition, the rotational position detector may be a rotary encoder, and the movement position detector may be a linear encoder. In this case, transmission encoders can be used to allow high definition, a relatively large scale-sensor gap, and easy assembly. Furthermore, a recording apparatus including the liquid-ejecting device for recording on a medium can provide the advantages described above.

### BRIEF DESCRIPTION OF THE DRAWINGS

The invention will be described with reference to the accompanying drawings, wherein like numbers reference like elements.

FIG. 1 is a perspective view of an example of an inkjet printer as a recording apparatus according to an embodiment of the invention.

FIG. 2 is a perspective view showing the inner structure of the main part of the,printer shown in FIG. 1.

FIG. 3 is a schematic sectional view of the printer shown in FIG. 1.

FIG. 4 is a front perspective view of a linear encoder and its vicinity of the printer shown in FIG. 1.

FIG. 5 is a rear perspective view of the linear encoder and its vicinity of the printer shown in FIG. 1.

FIG. 6 is a side view of the linear encoder and its vicinity of the printer shown in FIG. 1.

FIG. 7 is a rear perspective view of a rotary encoder and its vicinity of the printer shown in FIG. 1.

FIG. 8 is a perspective view of the rotary encoder shown in FIG. 7.

FIG. 9A is a side view of a linear scale subjected to a surface treatment that adapts it to ink.

FIG. 9B is a side view of a linear scale subjected to an ink-repellent surface treatment.

FIG. 10 is a graph showing measurements of decreases in transmittance due to adhesion of a water-based ink to a surface of a linear scale.

### DESCRIPTION OF EXEMPLARY EMBODIMENTS

Embodiments of the invention will now be described with reference to the drawings. The embodiments below should not be construed as limiting the scope of the invention, and not all features described in the embodiments are essential for the invention.

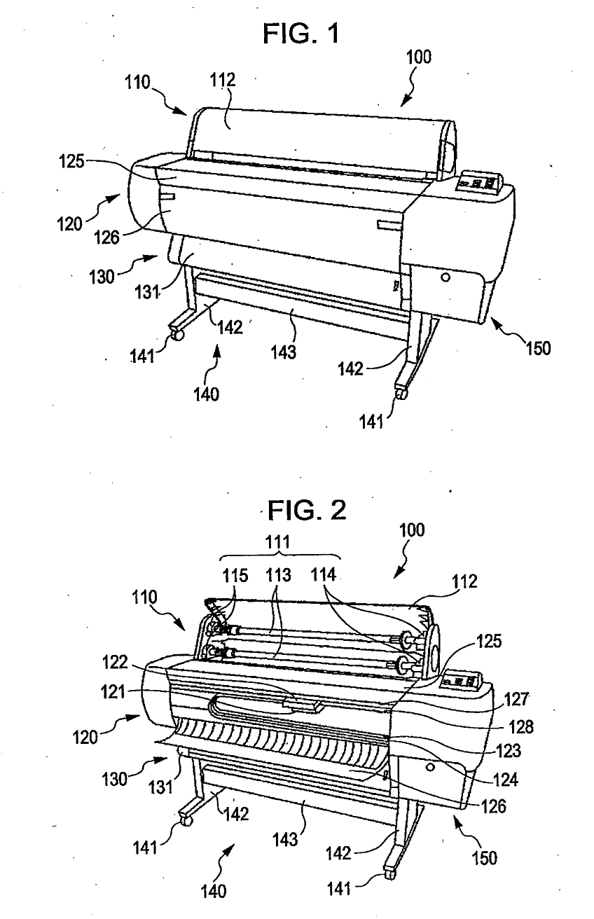

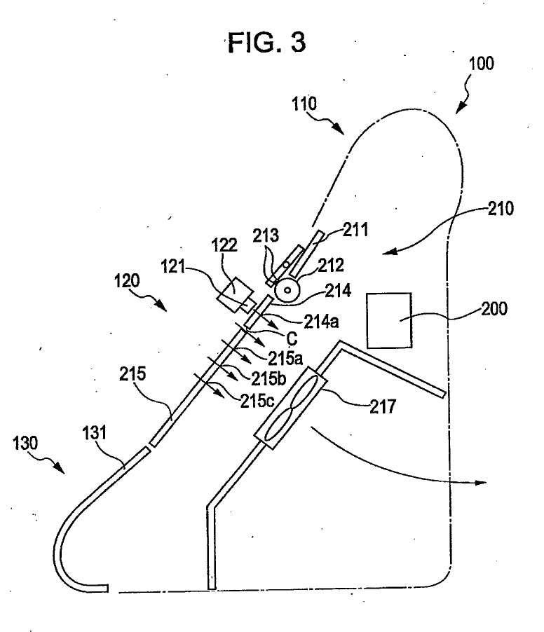

FIG. 1 is a perspective view of an example of a printer as a recording apparatus according to an embodiment of the invention. FIG. 2 is a perspective view showing the inner structure of the main part of the printer. FIG. 3 is a schematic sectional view of the printer. In FIGS. 1 to 3, a printer 100 is a large inkjet printer capable of recording on relatively large sheets such as AO sheets and BO sheets according to the Japanese Industrial Standards (JIS). This printer 100 includes, in order from top to bottom, a feeding section 110, a recording section 120, a transporting section 210, an ejecting section 130, and a leg section 140. The recording section 120 and the transporting section 210 (liquid-ejecting device) include characteristic parts of this embodiment. The printer 100 further includes a control unit 200 that controls the recording section 120 and the transporting section 210. The feeding section 110 can be detached from the recording section 120, the transporting section 210, and the ejecting section 130, which are integrated. These sections 110, 120, 210, and 130 constitute the main body of the printer 100, and the leg section 140 can be detached therefrom.

In FIG. 1, the feeding section 110 is disposed so as to extend backward from the top of the recording section 120. In FIG. 2, the feeding section 110 includes two diagonally arranged roll holders 111 that can hold rolled paper (sheets of paper). A flip-up rolled paper cover 112 is attached to the front of the feeding section 110 so as to cover the roll holders 111. This rolled paper cover 112 can prevent contamination of rolled paper and ensure user safety.

The roll holders 111 each include a spindle 113 that holds a rolled paper and a pair of spindle bearings 114 and 115 attached to the inner surfaces of sidewalls of the feeding section 110 to allow the attachment/detachment and suspension of the spindle 113. After a rolled paper is attached to the center of the spindle 113, both ends thereof are attached to the spindle bearings 114 and 115, which rotatably support the spindle 113. The top portion of the rolled paper cover 112 is rotatably supported so that a user can easily open the rolled paper cover 112 by lifting the bottom portion thereof and close the rolled paper cover 112 by pushing the bottom portion downward. The rolled paper cover 112 can, for example, reduce the time for replacement of rolled paper.

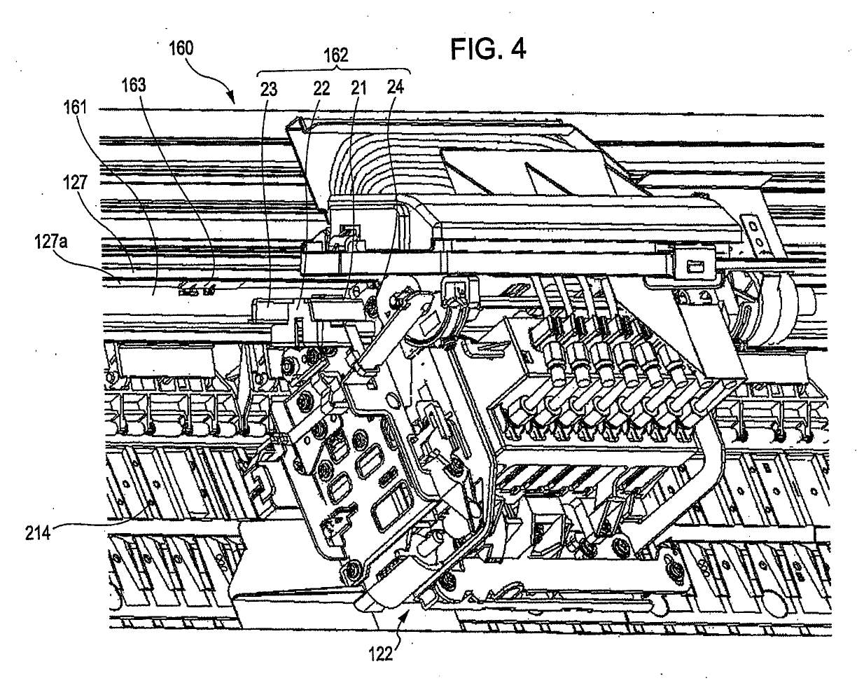

The recording section 120 includes a recording head (ejection head) 121, a carriage 122 carrying the recording head 121, a flexible flat cable (FFC) 123 that connects the recording head 121 to the control unit 200, and ink tubes 124 that connect the recording head 121 to ink cartridges containing ink (not shown). As one of the characteristic parts of this embodiment, the recording section 120 further includes a linear encoder 160 (for example, see FIG. 4) that detects the movement position of the carriage 122 in the main scanning direction. The linear encoder 160 will be described later in detail.

The recording head 121 includes a black ink recording head that ejects a black ink and color ink recording heads that eject color inks such as yellow, light cyan, cyan, light magenta, and magenta inks. The recording head 121 has pressure-generating chambers and nozzles communicating therewith. The pressure-generating chambers store ink and apply a predetermined pressure to the ink to eject ink droplets of controlled size from the nozzles toward a rollde paper.

The carriage 122 is suspended on a guide rail 127 with a roller and is coupled to a carriage belt 128. The guide rail 127 extends in the main scanning direction. As a carriage actuator (not shown) actuates the carriage belt 128, the carriage 122 reciprocates with the movement of the carriage belt 128 while being guided by the guide rail 127.

The FFC 123 transmits recording signals from the control unit 200 to the recording head 121. An end of the FFC 123 is connected to a connector of the control unit 200 while the other end is connected to a connector of the recording head 121. The ink tubes 124 are provided for the inks of the individual colors. An end of each ink tube 124 is connected to the corresponding ink cartridge through an ink-supplying unit (not shown) while the other end is connected to the corresponding recording head. The ink tubes 124 supply the inks from the ink cartridges to the recording head 121 when the ink-supplying unit applies a pressure to the inks.

A top cover 125 and a front cover 126 are attached to the recording section 120 so as to cover, for example, the recording head 121 and the carriage 122. The rear portion of the top cover 125 is rotatably supported so that the top cover 125 can be opened by lifting the front portion thereof or closed by pushing it downward. The bottom portion of the front cover 126 is rotatably supported so that the front cover 126 can be opened by pushing the top portion thereof downward or closed by lifting it. A user can open the top cover 125 and the front cover 126 to perform, for example, maintenance of the interior of the printer 100.

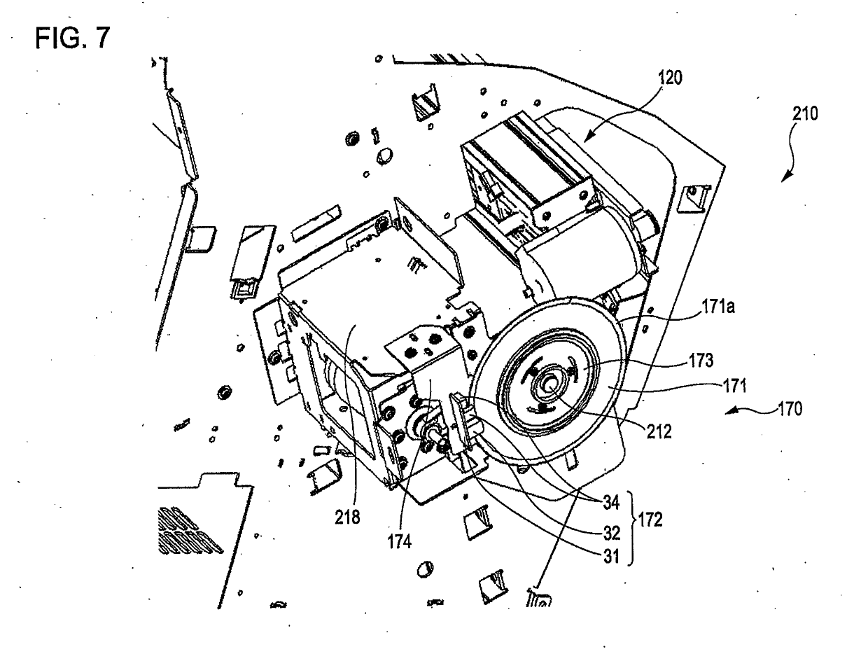

In FIG. 3, the transporting section 210 includes a flat feed guide 211 extending from the feeding section 110 to the recording section 120, a feed roller 212 and driven rollers 213 which are disposed opposite each other and can be moved into or out of contact with each other, a flat platen 214 disposed opposite the recording head 121 mounted on the carriage 122, and a flat paper-attracting portion 215 extending from the recording section 120 to the ejecting section 130. As one of the characteristic parts of this embodiment, the transporting section 210 further includes a rotary encoder 170 (for example, see FIG. 7) that detects the rotational position of the feed roller 212. The rotary encoder 170 will be described later in detail.

A surface of the feed guide 211 serves as a sheet-transporting surface. A surface of the paper-attracting portion 215 serves both as a sheet-transporting surface and as a sheet-attracting surface. The paper-attracting portion 215 has three rows of suction holes 215a, 215b, and 215c. These rows are arranged in the sub-scanning direction so as to extend in the main scanning direction. A fan 217 is disposed inside the recording section 120 to suck outside air through the suction holes 215a, 215b, and 215c so that the paper-attracting portion 215 can attract a rolled paper being transported thereon.

A surface of the platen 214 serves both as a sheet-transporting surface and as a sheet-attracting surface. The platen 214 has a row of suction holes 214a extending in the main scanning direction. The fan 217 sucks outside air through the suction holes 214a so that the platen 214 can attract a rolled paper being transported thereon. In particular, the platen 214 can maintain high recording accuracy even for recording on a wide rolled paper because the platen 214 reliably attracts the rolled paper over the width thereof and keeps it flat.

In FIGS. 1 and 2, the ejecting section 130 includes an eject guide 131 defining part of a path in which a rolled paper is transported in the sub-scanning direction and an eject roller (not shown) that conveys the rolled paper in the sub-scanning direction. The eject guide 131 serves as a sheet-transporting surface. A cartridge holder 150 holding the ink cartridges is disposed on the right side of the ejecting section 130 in FIGS. 1 and 2.

The leg section 140 includes two legs 142 having rollers 141 for movement and a reinforcing rod 143 bridging the two legs 142. The main body of the printer 100 is placed on the legs 142 and is fixed thereto with screws. The rollers 141 allow a user to easily move the printer 100 to, for example, check the backside of the printer 100 for maintenance or to change the placement thereof.

The control unit 200 shown in FIG. 3 includes a main substrate (not shown) constituting a printer controller. The main substrate has various circuit elements (not shown) such as control elements and storage elements (e.g., a CPU, a ROM, a RAM, and an ASIC) to control, for example, the feeding section 110, the recording section 120, and the transporting section 210, which constitute a print engine.

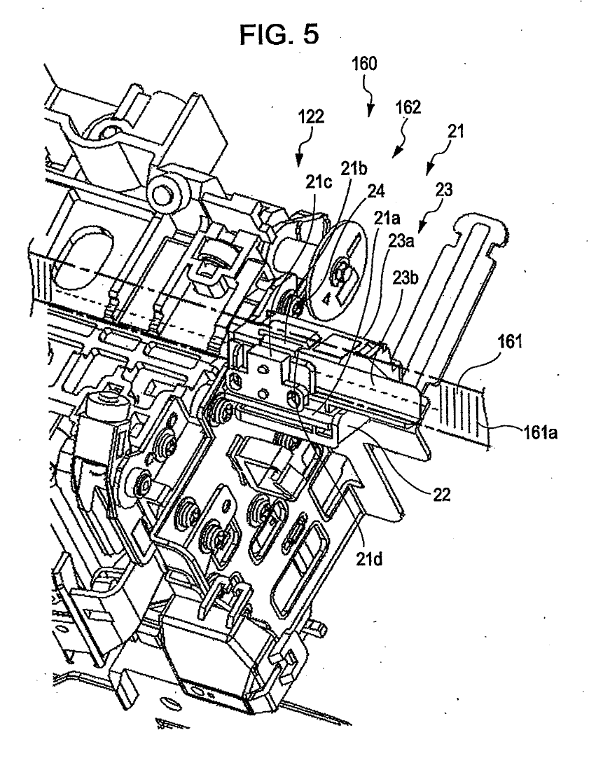

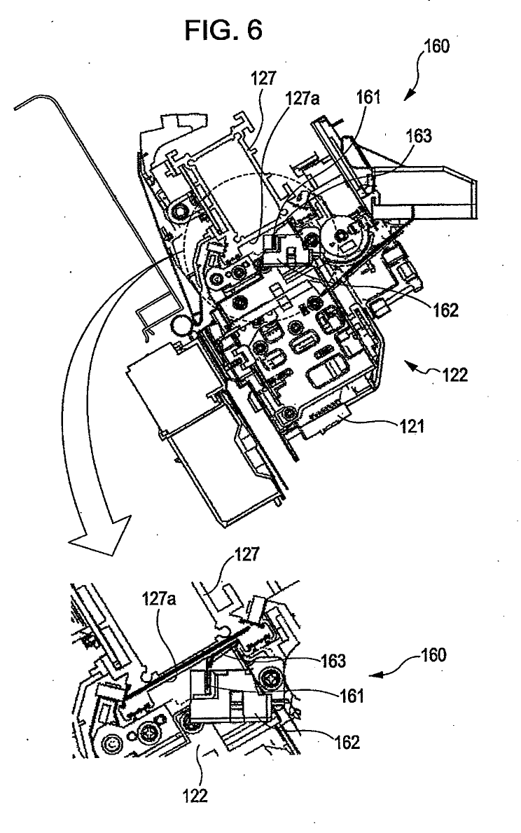

FIG. 4 is a front perspective view of the linear encoder 160 and its vicinity. FIG. 5 is a rear perspective view of the linear encoder 160 and its vicinity. FIG. 6 is a side view of the linear encoder 160 and its vicinity. The linear-encoder 160 includes a strip-shaped linear scale (movement position detection scale) 161 and a sensor unit 162. The linear scale 161 is formed of a transparent, translucent, or nontransparent material such as a plastic, for example, polyethylene terephthalate (PET), which has high transmittance and is advantageous in terms of cost. The linear scale 161 has a detection scale pattern 161aformed so as to extend in the longitudinal direction thereof.

The detection scale pattern 161a is formed as light-shielding vertical lines arranged at predetermined intervals if the linear scale 161 is formed of a transparent material, or is formed as vertical slits arranged at predetermined intervals if the linear scale 161 is formed of a translucent or nontransparent material, that is, a light-shielding material.

A scale surface of the linear scale 161 is parallel to the vertical direction. Both ends of the linear scale 161 are fixed to hooks (not shown) disposed at both ends of the guide rail 127. The top side of the linear scale 161 is fixed to the bottom surface 127a of the guide rail 127 in close contact using fixing hooks 163. The fixing hooks 163 are formed of, for example, rectangular metal plates and are substantially L-shaped in cross section. An end of each fixing hook 163 holds the top side of the linear scale 161 while the other end is fixed to the bottom surface 127a of the guide rail 127 using, for example, screws. The fixing hooks 163 are arranged at predetermined intervals to fix the linear scale 161 because the linear scale 161 is elongated.

The sensor unit 162 includes a sensor 21, a sensor holder 22, a cover 23, and a screw 24. The sensor 21 includes a substrate 21a on which a light-receiving element 21b, a light-emitting element 21c, and another circuit element 21d are mounted. The light-receiving element 21band the light-emitting element 21c are disposed opposite each other and are separated. The sensor holder 22 is formed in a substantially box shape so as to cover the bottom of the sensor 21. The cover 23 includes a sensor cover 23a covering the sensor 21 and a scale cover 23bcovering the linear scale 161 near the carriage 122.

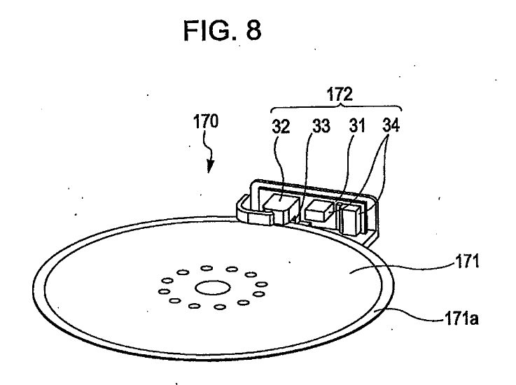

FIG. 7 is a rear perspective view of the rotary encoder 170 and its vicinity. FIG. 8 is a perspective view of the rotary encoder 170. The rotary encoder 170 includes a circular rotary scale (rotational position detection scale) 171 and a sensor unit 172. The rotary scale 171 is formed of a transparent, translucent, or nontransparent material such as a plastic, for example, PET. The rotary scale 171 has a detection scale pattern 171a formed on the rim thereof.

The detection scale pattern 171a is formed as light-shielding radial lines arranged at predetermined intervals if the rotary scale 171 is formed of a transparent material, or is formed as radial slits arranged at predetermined intervals if the rotary scale 171 is formed of a translucent or nontransparent material, that is, a light-shielding material. The center of the rotary scale 171 is held by an annular flange 173 and is fixed using screws. The flange 173 is formed of, for example, a rigid plastic and has a central hole that can be fitted into the feed roller 212.

The sensor unit 172 includes a substrate 31 on which a light-receiving element 32, a light-emitting element 33, and other circuit elements 34 are mounted. The light-receiving element 32 and the light-emitting element 33 are disposed opposite each other and are separated. The sensor unit 172 is fixed to a fixing plate 174 using screws such that the detection scale pattern 171a of the rotary scale 171 is located between the light-receiving element 32 and the light-emitting element 33. The fixing plate 174 is formed of, for example, a rectangular plastic plate and is substantially L-shaped in cross section. An end of the fixing plate 174 is fixed to the sensor unit 172 using screws while the other end is fixed to a frame 218 of the main body of the printer 100 using screws.

As mentioned in the description of the related art, foreign matter such as paper dust and ink mist tends to be suspended during the transportation and recording of a sheet of paper. Such foreign matter can adhere to the linear scale 161 and the rotary scale 171 and decrease transportation accuracy and recording accuracy. In this embodiment, each of the linear scale 161 and the rotary scale 171 is subjected to a surface treatment that adapts both surfaces thereof to ink. This treatment can prevent an extreme decrease in detection accuracy because the treated surfaces do not repel ink adhering thereto or form it into droplets. This phenomenon will be described below in detail with reference to the drawings using the linear encoder 160 as an example, although the same holds true for the rotary encoder 170.

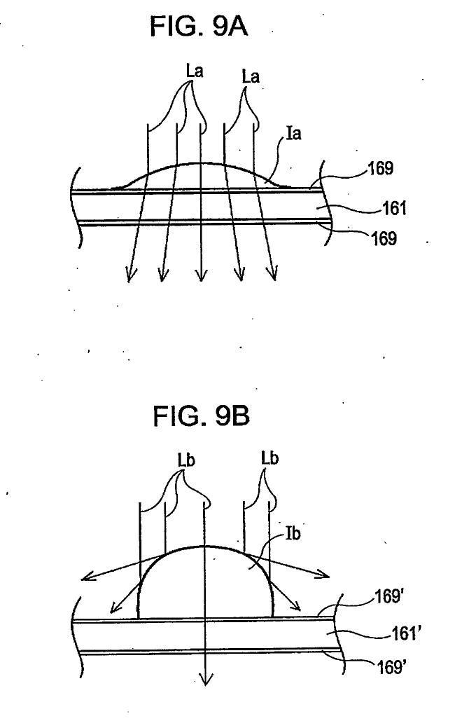

FIG. 9A is a side view of the linear scale 161, which is subjected to a surface treatment that adapts the linear scale 161 to ink. FIG. 9B is a side view of a linear scale 161′ subjected to an ink-repellent surface treatment. In FIG. 9A, an ink Ia adhering to one of treated surfaces 169 of the linear scale 161 conforms to the treated surface 169 and becomes flat thereon. Most of light La from the light-emitting element 21c is not reflected and passes through the ink Ia and the linear scale 161, which includes the treated surfaces 169, in substantially the entire area of the surface of the ink Ia to enter the light-receiving element 21b. This surface treatment can thus prevent an extreme decrease in the detection accuracy of the linear encoder 160 even if the ink Ia remains on the treated surface 169 of the linear scale 161. Also, when the ink Ia flows down, it can separate and remove paper dust, for example, from the treated surface 169 of the linear scale 161.

In FIG. 9B, an ink Ib adhering to one of treated surfaces 169′ of the linear scale 161′ is repelled and formed into a droplet on the treated surface 169′. Light Lb from the light-emitting element 21c is not reflected and passes through the ink Ib and the linear scale 161′, which includes the treated surfaces 169′, in substantially the center of the surface of the ink Ib to enter the light-receiving element 21b. The other area of the surface of the ink Ib, however, scatters (diffuses) most of the light Lb. Hence, an extreme decrease in the detection accuracy of the linear encoder 160 is inevitable with the ink Ib adhering to the treated surface 169′ of the linear scale 161′. The ink lb must thus be removed to prevent an extreme decrease in the detection accuracy of the linear encoder 160.

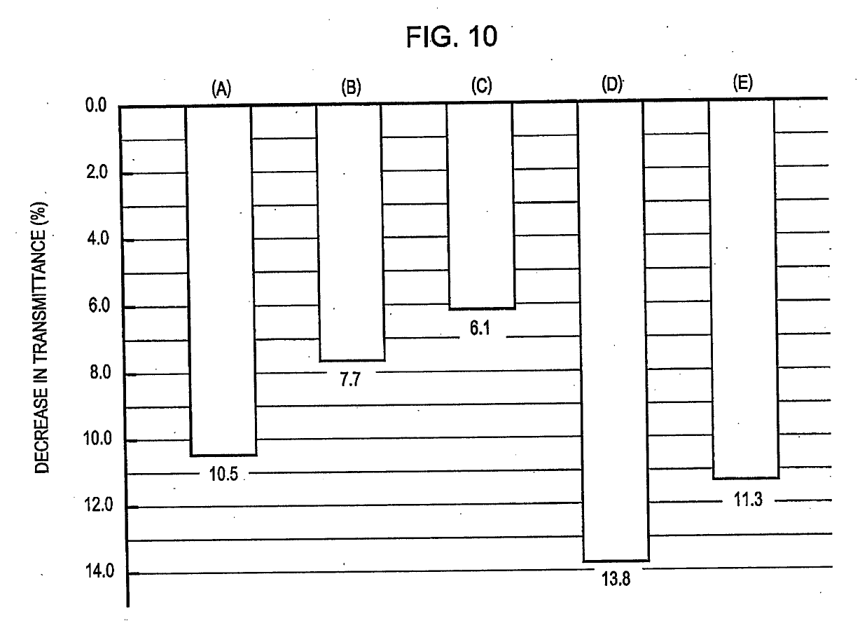

An example of the surface treatment for adapting the linear scale 161 to ink is a surface treatment that imparts an affinity for ink. For water-based inks, for example, both surfaces of the linear scale 161 may be subjected to a hydrophilic surface treatment to enhance wettability between the inks and the surfaces of the linear scale 161. This surface treatment lowers surface tension to decrease contact angle. An example of the surface treatment that imparts an affinity for ink is coating with a surfactant or a hydrophilic photocatalyst (non-water-repellent agent). On the other hand, an example of the ink-repellent surface treatment is coating with a water repellent. The effects of these surface treatments will be described below with reference to FIG. 10.

FIG. 10 is a graph showing measurements of decreases in transmittance, due to adhesion of a water-based ink to the surfaces of the linear scale 161. FIG. 10 shows the results of Example (A) where a silicone surfactant (e.g., “BYK®-348,”a registered trademark of BYK-Chemie Japan KK) was used, Example (B) where an acetylene glycol surfactant (e.g., “OLFINE® E1010,” a registered trademark of Nissin Chemical Industry Co., Ltd.) was used, Example (C) where a hydrophilic photocatalyst (e.g., “HYDROTECTO,” a trademark of TOTO LTD.) was used, Comparative Example (D) where a fluoropolymer water repellent was used, and Comparative Example (E) where the linear scale 161 was not subjected to any surface treatment.

According to FIG. 10, Examples (A), (B), and (C) resulted in improvements in transmittance of 1.07 times, 1.47 times, and 1.84 times, respectively, relative to Comparative Example (E) while Comparative Example (D) resulted in a further decrease in transmittance, namely, 0.82 time relative to Comparative Example (E). These results demonstrated that the surface treatment for adapting the linear scale 161 to ink can prevent an extreme decrease in the detection accuracy of the linear encoder 160 even if ink remains on the surfaces of the linear scale 161. The results also demonstrated that an extreme decrease in the detection accuracy of the linear encoder 160 is inevitable if the linear scale 161 have ink-repellent or untreated surfaces with ink remaining thereon.

The technique described above is applied to both the linear encoder 160 and the rotary encoder 170 in this embodiment, although the technique may also be applied to only either of them. If the gap between the nozzle surface of the recording head 121 and the top surface of the platen 214 (sheet of paper) is adjustable, the technique may also be applied to an encoder used for adjusting the gap. In addition, the technique is applied to a linear encoder including a vertical linear scale in this embodiment, although the technique may also be applied to a linear encoder including a horizontal linear scale. Furthermore, the technique is applied to transmission encoders in this embodiment, although the technique may also be applied to reflection encoders, or to magnetic encoders if magnetic inks are used instead of water-based inks. If solvent-based inks are used instead of water-based. inks, scale surfaces may be subjected to a surface treatment that adapts the surfaces to the solvent used.

Examples of liquid-ejecting devices that eject a liquid selected according to application from a liquid-ejecting head to deposit the liquid onto a medium include devices having a head for ejecting a colorant in the manufacture of color filters for liquid crystal displays, a head for ejecting an electrode material (conductive paste) in the formation of electrodes for organic electroluminescent (EL) displays and field-emission displays (FEDs), a head for ejecting a biological organic material in the manufacture of biochips, and a sample-ejecting head serving as a high-precision pipette. Liquid-ejecting devices according to embodiments of the invention may be applied to various recording apparatuses having a position detector, including fax machines and copiers.

What is claimed is:

1. A liquid-ejecting device comprising:
a feed roller that conveys a medium;
an ejection head that ejects a liquid while reciprocating along the medium;
a rotational position detector including a rotational position detection scale to detect a rotational position of the feed roller; and
a movement position detector including a movement position detection scale to detect a movement position of the ejection head;
wherein the rotational position detection scale and/or the movement position detection scale is subjected to a surface treatment that adapts at least one surface thereof to the liquid.

2. The liquid-ejecting device according to claim 1, wherein the surface treatment imparts an affinity for the liquid.

3. The liquid-ejecting device according to claim 2, wherein the surface treatment is coating with a surfactant.

4. The liquid-ejecting device according to claim 2, wherein the surface treatment is coating with a hydrophilic photocatalyst.

5. The liquid-ejecting device according to claim 1, wherein the rotational position detection scale and the movement position detection scale are formed of polyethylene terephthalate.

6. The liquid-ejecting device according to claim 1, wherein the rotational position detector is a rotary encoder and the movement position detector is a linear encoder.

7. A recording apparatus for recording on a medium, comprising the liquid-ejecting device according to claim 1.
